(19) United States
(12) Patent Application Publication
(10) Pub. No.: US 2025/0337916 A1
(43) Pub. Date: Oct. 30, 2025

(54) BLOCK-LEVEL SIGN PREDICTION ADAPTATION

(71) Applicant: Tencent America LLC, Palo Alto, CA (US)

(72) Inventors: Xin ZHAO, San Jose, CA (US); Lien-Fei CHEN, Palo Alto, CA (US); Roman CHERNYAK, Santa Clara, CA (US); Madhu PERINGASSERY KRISHNAN, Mountain View, CA (US); Biao WANG, San Jose, CA (US); Shan LIU, San Jose, CA (US)

(73) Assignee: Tencent America LLC, Palo Alto, CA (US)

(21) Appl. No.: 19/258,786

(22) Filed: Jul. 2, 2025

Related U.S. Application Data
(63) Continuation of application No. PCT/US2024/025573, filed on Apr. 19, 2024.
(60) Provisional application No. 63/460,883, filed on Apr. 20, 2023.

(51) Int. Cl. H04N 19/14; H04N 19/176; H04N 19/18

(52) U.S. Cl. CPC H04N 19/14; H04N 19/176; H04N 19/18

(57) ABSTRACT

An apparatus for video decoding includes processing circuitry configured to receive a coded video bitstream comprising coded information of one or more pictures, determine a specific number that defines a count of predicted signs in a sign prediction of transform coefficients for a current block in a current picture based on information of the current block or the current picture, determine one or more transform coefficients for the sign prediction according to the specific number, calculate cost values respectively associated with combinations of signs for the one or more transform coefficients, determine a specific combination of signs for the one or more transform coefficients based on the cost values associated with the combinations of signs and reconstruct the current block according to the specific combination of signs for the one or more transform coefficients.

### INCORPORATION BY REFERENCE

The present application is a continuation of International Application No. PCT/US2024/025573, entitled “BLOCK-LEVEL SIGN PREDICTION ADAPTATION” and filed on Apr. 19, 2024, which claims the benefit of priority to U.S. Provisional Application No. 63/460,883, “BLOCK-LEVEL SIGN PREDICTION ADAPTATION” filed on Apr. 20, 2023. The entire disclosures of the prior applications are hereby incorporated by reference.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

Some aspects of the disclosure provide a method of processing visual media data. The method includes processing a bitstream of visual media data according to a format rule. The format rule specifies that a number that defines a count of predicted signs in a sign prediction of transform coefficients for a current block in a current picture is determined based on information of the current block or the current picture. Further, the format rule specifies that one or more transform coefficients for the sign prediction are determined based on the number, absolute values of the one or more transform coefficients are in the bitstream and cost values respectively associated with combinations of signs are calculated for the one or more transform coefficients. A first cost value associated with a first combination of signs measures a discontinuity between reconstructed samples of the current block according to the first combination of signs and reconstructed samples of one or more neighboring blocks. The format rule further specifies that a specific combination of signs for the one or more transform coefficients that has a minimal cost value among the cost values is determined, and the current block is reconstructed according to the specific combination of signs for the one or more transform coefficients.

Some aspects of the disclosure provide a method for video encoding. The method includes determining a specific number that defines a count of predicted signs in a sign prediction of transform coefficients for a current block in a current picture based on information of the current block or the current picture, determining one or more transform coefficients for the sign prediction based on the specific number, calculating cost values respectively associated with combinations of signs for the one or more transform coefficients, determining a specific combination of signs for the one or more transform coefficients that has a minimal cost value among the cost values and reconstructing the current block according to the specific combination of signs for the one or more transform coefficients.

In some examples, to calculate the cost values, the method includes calculating a first cost value associated with a first combination of signs for the one or more transform coefficients by measuring a discontinuity between reconstructed samples of the current block according to the first combination of signs and reconstructed samples of one or more neighboring blocks.

In some examples, to determine the specific number, the method includes determining the specific number that is a minimum of a first number that indicates an upper limit of predicted signs for a current transform block of the current block and a second number of nonzero transform coefficients in a current transform block of the current block, the first number is assigned based on a maximum number of predicted signs for transform blocks in the current picture. The method also includes signaling the maximum number of predicted signs as a syntax element at a picture level in a coded video bitstream that includes coded information of the current picture, the syntax element indicates the maximum number of predicted signs for the transform blocks in the current picture.

In some examples, the method includes deriving the second number of nonzero transform coefficients in the current transform block of the current block, and adjusting the first number based on the second number of nonzero transform coefficients in the current transform block.

In some examples, the method includes adjusting the first number based on a sum of absolute values of non-zero transform coefficients of the current transform block.

In some examples, the method includes adjusting the first number based on at least one of whether a secondary transform is applied, whether a specific secondary transform kernel is applied, whether the current block is an intra coded block and whether the current block is an inter coded block.

In some examples, the method includes adjusting the first number based on at least one of an availability of neighboring reconstructed samples, a value of quantization parameter for a neighboring block and a relative location of the current block in a current coding tree unit (CTU).

Some aspects of the disclosure provide an apparatus for video decoding. The apparatus includes processing circuitry configured to receive a coded video bitstream comprising coded information of one or more pictures, determine a specific number that defines a count of predicted signs in a sign prediction of transform coefficients for a current block in a current picture based on information of the current block or the current picture, determine one or more transform coefficients for the sign prediction according to the specific number, calculate cost values respectively associated with combinations of signs for the one or more transform coefficients, determine a specific combination of signs for the one or more transform coefficients based on the cost values associated with the combinations of signs and reconstruct the current block according to the specific combination of signs for the one or more transform coefficients.

In some examples, the processing circuitry is configured to calculate a first cost value associated with a first combination of signs for the one or more transform coefficients by measuring a discontinuity between reconstructed samples of the current block according to the first combination of signs and reconstructed samples of neighboring blocks.

In some examples, the processing circuitry is configured to determine the specific combination that has a minimal cost value in the cost values.

In some examples, the processing circuitry is configured to parse the coded video bitstream to obtain a maximum number of predicted signs for transform blocks in the current picture from a syntax element signaled at a picture level for the current picture, a first number defines an upper limit of predicted signs for a current transform block of the current block being assigned according to the maximum number of predicted signs for transform blocks in the current picture. Further, the processing circuitry is configured to determine a second number of nonzero transform coefficients in the current transform block of the current block and select a minimum of the first number and the second number as the specific number.

In some examples, the processing circuitry is configured to parse a control flag for the syntax element from the coded video bitstream, the control flag is in at least one of a sequence parameter set (SPS) and a picture parameter set (PPS). When the control flag indicates the syntax element being used, the processing circuitry is configured to parse the coded video bitstream to obtain the first number from the syntax element signaled at the picture level.

In some examples, the processing circuitry is configured to derive the second number of nonzero transform coefficients in the current transform block of the current block, and adjust the first number based on the second number of nonzero transform coefficients.

In some examples, the processing circuitry is configured to parse absolute values of the transform coefficients of the current transform block from the coded video bitstream, and adjust the first number based on the absolute values of the transform coefficients.

In some examples, the processing circuitry is configured to adjust the first number based on a sum of the absolute values of the transform coefficients.

In some examples, the processing circuitry is configured to adjust the first number based on at least one of whether a secondary transform is applied, whether a specific secondary transform kernel is applied, whether the current block is an intra coded block, and whether the current block is an inter coded block.

In some examples, the processing circuitry is configured to adjust the first number based on an availability of neighboring reconstructed samples.

In some examples, the processing circuitry is configured to adjust the first number based on a value of quantization parameter for a neighboring block.

In some examples, the processing circuitry is configured to adjust the first number based on a relative location of the current block in a coding tree unit (CTU).

According to another aspect of the disclosure, an apparatus is provided. The apparatus includes processing circuitry. The processing circuitry can be configured to perform any of the described methods for video decoding/encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary block diagram of a communication system (100).

FIG. 2 is a schematic illustration of an exemplary block diagram of a decoder.

FIG. 3 is a schematic illustration of an exemplary block diagram of an encoder.

FIG. 4 shows a diagram for illustrating sign prediction in some examples.

FIG. 5 shows a flow chart outlining a decoding process according to some embodiments of the disclosure.

FIG. 6 shows a flow chart outlining an encoding process according to some embodiments of the disclosure.

FIG. 7 is a schematic illustration of a computer system in accordance with an embodiment.

### DETAILED DESCRIPTION OF EMBODIMENTS

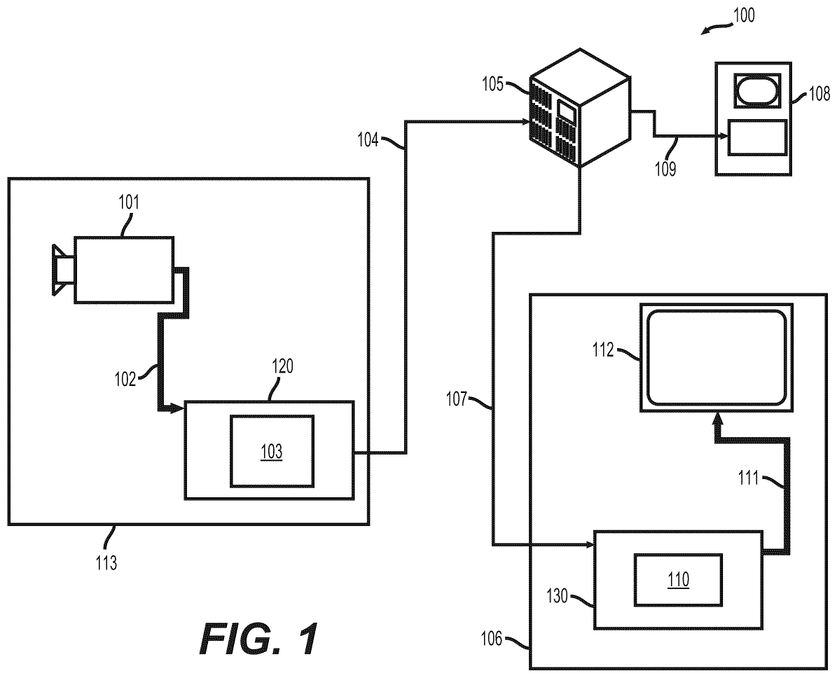

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

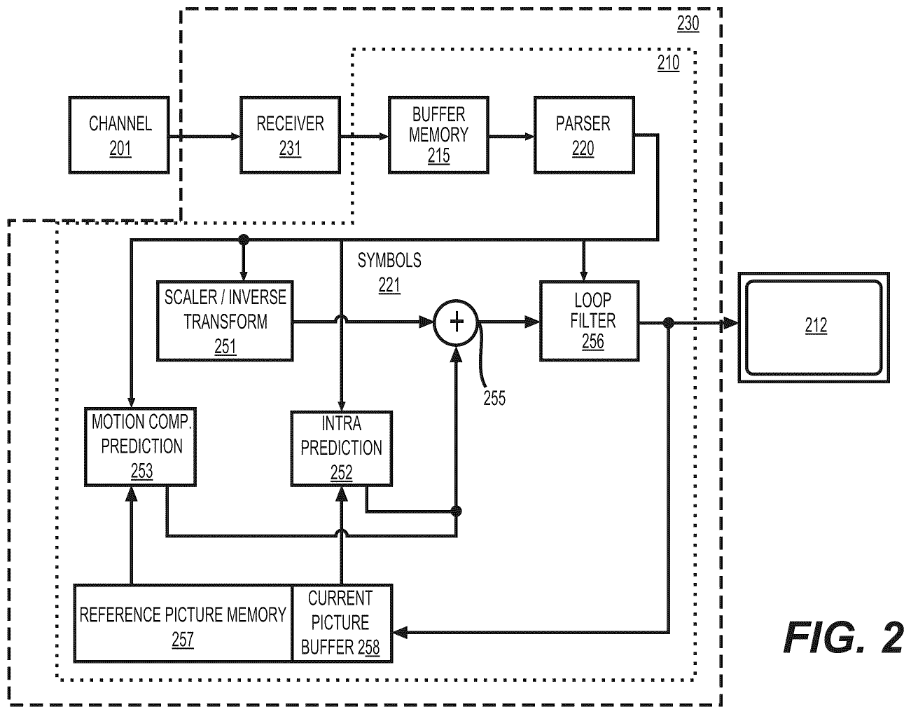

FIG. 2 shows an exemplary block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an embodiment, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

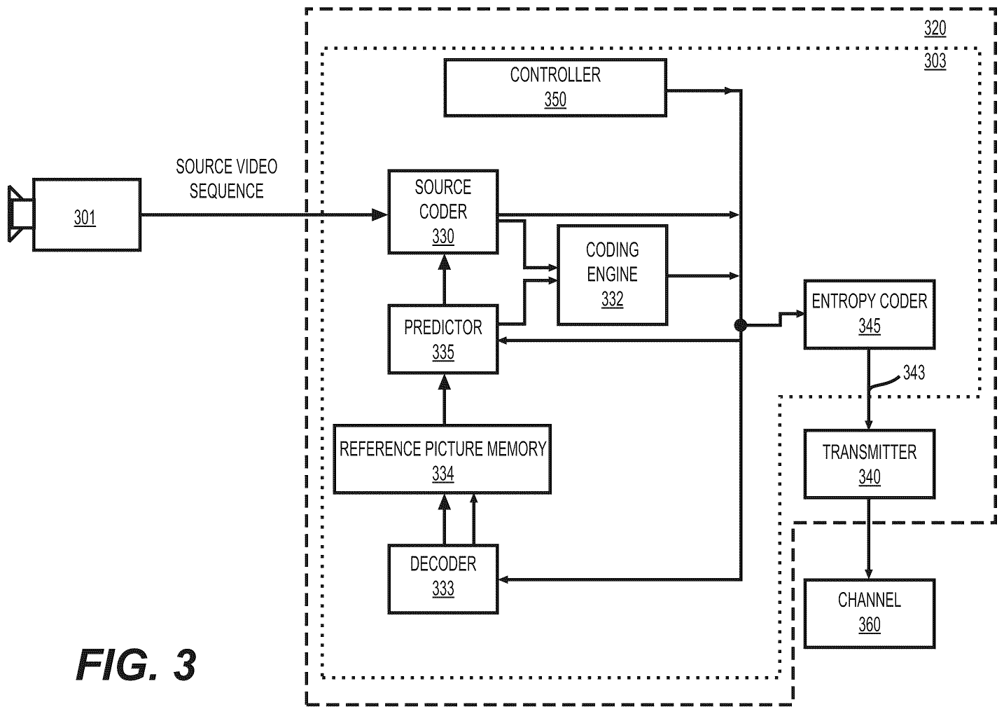

FIG. 3 shows an exemplary block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an embodiment, the video encoder (303) may code and compress the pictures of the source video sequence into a coded video sequence (343) in real time or under any other time constraints as required. Enforcing appropriate coding speed is one function of a controller (350). In some embodiments, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some embodiments, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an embodiment, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an embodiment, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in usc.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some embodiments of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an embodiment, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an embodiment, the video encoders (103) and (303) and the video decoders (110) and (210) can be implemented using one or more integrated circuits. In another embodiment, the video encoders (103) and (303), and the video decoders (110) and (210) can be implemented using one or more processors that execute software instructions.

Aspects of the disclosure provide techniques for block level sign prediction adaptation.

In some examples, sign prediction of transform coefficients is used to improve coding efficiency. In some examples, prior to encoding coefficients in a TU, an encoder can determine which signs to predict, and predict them. The encoder performs hypothesis processing during RDO decision making.

In an example, the encoder initially dequantizes the TU and then chooses n coefficients (n is a positive integer) for which signs will be predicted. In an example, with the n coefficients, 2ⁿ border reconstructions (respectively corresponding to 2ⁿ combinations of positive and negative signs for the n coefficients) are performed, one border reconstruction per unique combination of signs (each sign can be positive or negative) for the n coefficients. Further, a cost value associated with each hypothesis (a hypothesis corresponds to a combination of signs) is calculated according to the concept of image continuity at the block border. The sign prediction can be performed by selecting the hypothesis that minimizes the cost value.

For example, when two signs are chosen for the sign prediction, then there can be 4 possible combinations (4 hypothesis) as (+, +), (+, −), (−, +), (−, −). For all four combinations, the cost function is calculated and the combination with the minimum cost is selected as a sign predictor combination. The same process is applied when more signs are predicted with more combinations to be tried, and trade-off can be determined between the complexity and compression efficiency.

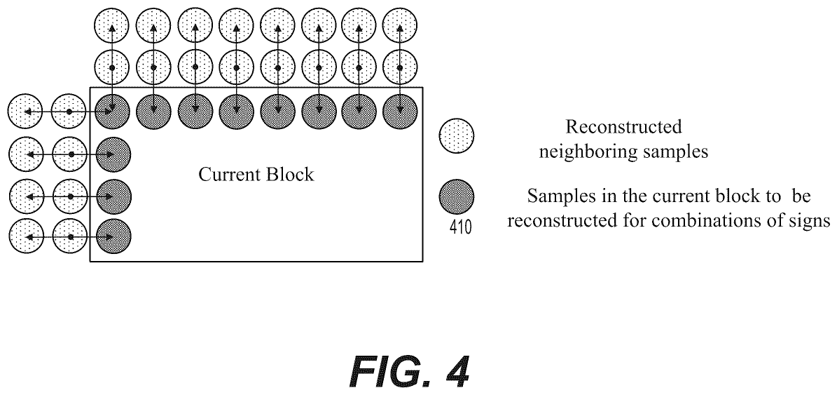

FIG. 4 shows a diagram for illustrating sign prediction in some examples. In some examples, reconstructed residuals for both negative and positive sign combinations of applicable transform coefficients are calculated and then a hypothesis is selected by minimizing a cost function. In the FIG. 4 examples, some samples in the current block, such as the first row of samples in the current block and/or the first column of samples in the current block, can be reconstructed for both negative and positive sign combinations of applicable transform coefficients. Then, for each sign combination in the both negative and positive sign combinations, a cost value can be calculated based on the reconstructed samples in the current block for the sign combination and the reconstructed neighboring samples. It is noted that in some examples, residual reconstruction for each sign combination is performed instead of sample reconstruction for each sign combination in order to reduce computation.

In some examples, the cost function is defined as discontinuity measure across block boundary. In the FIG. 4 example, residuals of the border samples (410) are reconstructed according to each of the hypotheses of signs for transform coefficients. Then, cost values for the hypotheses are calculated based on a cost function. The one hypothesis with the smallest cost value is selected as a predictor for transform coefficient signs. In some examples, the cost function is defined as a sum of absolute second derivatives in the residual domain for the above row and left column of the current block, such as according to Eq. (1):

$$cost = {\sum }_{x = 0}^{w} \vert ( - {R}_{x , - 1} + 2 {R}_{x , 0} - {P}_{x , 1} ) - {r}_{x , 1} \vert + {\sum }_{y = 0}^{h} \vert ( - {R}_{- 1 , y} + 2 {R}_{0 , y} - {P}_{1 , y} ) - {r}_{1 , y} \vert \qquad Eq . ( 1 )$$

where R denotes reconstructed neighboring samples, P denotes prediction samples of the current block, r denotes the sample residual of a hypothesis, w denotes the width of the current block and the h denotes height of the current block. In some examples, certain terms do not change with the hypotheses, and can be calculated once for the current block and stored in a buffer. For example, (−R_{x,-1}+2R_{x,0}−P_{x,1}) (x∈0 . . . w), (−R_{-1,y}+2R_{0,y}−P_{1,y}) (y∈0 . . . h) can be calculated only once per block.

In some examples, a portion of the transform coefficients are selected for the sign prediction. In an example, the transform coefficients with the largest K qIdx value of the top-left 4×4 area are selected, (e.g., K is a positive integer), qIdx value is the transform coefficient level after compensating the impact from the multiple quantizers in dependent quantization. A larger qIdx value will produce a larger de-quantized transform coefficient level. In an example, qIdx is derived according to Eq. (2):

$$qIdx = ( abs ( level ) ≪ 1 ) - ( state \& 1 ) \qquad Eq . ( 2 )$$

where level denotes the transform coefficient level parsed from the bitstream and state is a variable maintained by the encoder and decoder in dependent quantization.

In some examples, the sign prediction area can be extended to maximum of 32×32. For example, signs of top-left M×N block are predicted. The values of M and N can be computed according to Eq. (3) and Eq. (4):

$$M = min ( Tw , max W ) \qquad Eq . ( 3 )$$

$$N = min ( Th , max H ) \qquad Eq . ( 4 )$$

where, Tw and Th are the width and height of the transform block, maxW and maxH are the width and height of a maximum area. In some examples, the maximum area for sign prediction is set to 32×32. In some examples, the maximum area for sign prediction is not always set to 32×32. In an example, an encoder sets the maximum area (maxW, maxH) based on certain parameters, such as configuration, sequence class, QP and the like, and signals the maximum area in SPS.

In some related examples, the maximum number of predicted signs is kept unchanged. The sign prediction is also applied to low-frequency non-separable transform (LFNST) blocks. For example, for an LFNST block, a maximum of predetermined number (e.g., 4, 8 and the like) coefficients in the top-left 4×4 area are allowed to be sign predicted.

In a related example, the number of maximum predicted signs (denoted as NumSignPred) is specified in a sequence parameter set. In another related example, a default configuration sets NumSignPred as 8, and the minimum value between 8 and the number of nonzero coefficients in the area for sign prediction is applied as the number of predicted signs in a transform block. In another related example, a smaller value of NumSignPred is used for higher bitrate test configuration to reduce the overall encoding runtime.

According to an aspect of the disclosure, the bitrate is usually not evenly distributed among different pictures or different blocks, a universal sequence level setting of NumSignPred may be suboptimal for achieving better coding gain vs runtime tradeoff.

It is noted that, in the present disclosure, the term transform can refer to primary transform (such as multiple transform selection (MTS) or non-separable primary transform (NSPT)), or secondary transform (such as non-separable secondary transform (NSST) or LFNST).

Some aspects of the present disclosure provide techniques to determine the number of predicted signs using frame-level and/or block level coded information, thus the number of predicted signs is adapted at frame level and/or block level. For example, encoder/decoder can determine a specific number that defines a count of predicted signs in a sign prediction of transform coefficients for a current block in a current picture based on information of the current block or the current picture. Then, one or more transform coefficients for the sign prediction according to the specific number. Cost values respectively associated with combinations of signs for the one or more transform coefficients are calculated. A specific combination of signs for the one or more transform coefficients is determined based on the cost values associated with the combinations of signs, and the current block is reconstructed according to the specific combination of signs for the one or more transform coefficients.

In some embodiments, a picture level syntax (e.g., pic_num_pred_signs) is signaled to indicate the maximum number of predicted signs for each transform block in the current picture. In an example, the actual number of predicted signs for a transform block is determined as the minimum value between pic_num_pred_signs and the number of nonzero transform coefficients in this transform block.

In some examples, the picture level syntax is used when a control flag of this syntax element in true in the sequence parameter set (SPS) or picture parameter set (PPS) and the like.

In some examples, the number of nonzero coefficients (N) is derived first for each transform block, then based on the value of N, the maximum number of predicted signs is further adjusted for this transform block. In an example, for greater value of N, the maximum number of predicted signs is reduced. In another example, for greater value of N, the maximum number of predicted signs is increased.

In some examples, the absolute values of the transform coefficients are parsed first for each transform block, then based on the absolute values of the nonzero coefficients, the maximum number of predicted signs are further adjusted for this transform block. In one example, for greater value of sum of absolute coefficient values, the maximum number of predicted signs for this transform block is reduced. In another example, for greater value of sum of absolute coefficient values, the maximum number of predicted signs for this transform block is increased.

In some examples, based on the coding mode information, the maximum number of predicted signs is further adjusted for this transform block. In an example, the coding mode information is whether secondary transform or a specific secondary transform kernel/index is applied. In another example, the coding mode information is whether the coding block is intra coded block or inter coded block.

In some examples, based on the availability of neighboring reconstruction samples, the maximum number of predicted signs is further adjusted for this transform block.

In an example, when the top, left or top-left neighboring reconstruction samples are not available, e.g., at picture boundary, the maximum number of predicted signs for the current transform block is adjusted with a different number (e.g., reduced or increased).

In some examples, based on the QP value applied of neighboring reconstruction samples, the maximum number of predicted signs is further adjusted for this transform block. In an example, when the neighboring block is coded with a higher QP value than the current block, the maximum number of predicted signs is reduced.

In some examples, based on the relative location of the current coding block in the current CTU, the maximum number of predicted signs is further adjusted for this transform block. In an example, when the current block is located at the top CTU boundary or left CTU boundary, the maximum number of predicted signs is reduced.

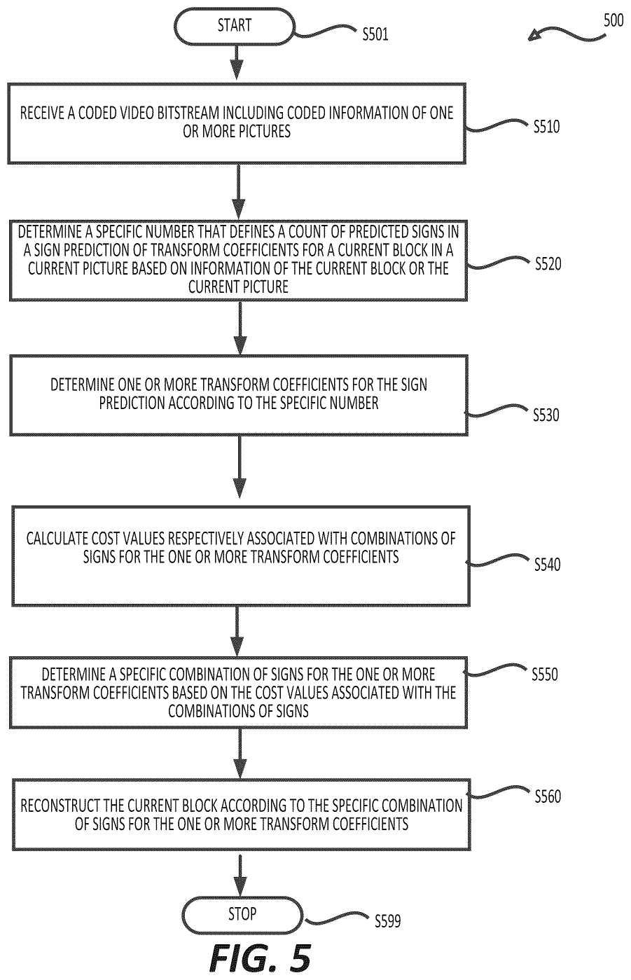

FIG. 5 shows a flow chart outlining a process (500) according to an embodiment of the disclosure. The process (500) can be used in a video decoder. In various embodiments, the process (500) is executed by processing circuitry, such as the processing circuitry that performs functions of the video decoder (110), the processing circuitry that performs functions of the video decoder (210), and the like. In some embodiments, the process (500) is implemented in software instructions, thus when the processing circuitry executes the software instructions, the processing circuitry performs the process (500). The process starts at (S501) and proceeds to (S510).

At (S510), a coded video bitstream including coded information of one or more pictures is received.

At (S520), a specific number that defines a count of predicted signs in a sign prediction of transform coefficients for a current block in a current picture is determined based on information of the current block or the current picture.

At (S530), one or more transform coefficients for the sign prediction are determined according to the specific number.

At (S540), cost values respectively associated with combinations of signs for the one or more transform coefficients are calculated.

At (S550), a specific combination of signs for the one or more transform coefficients is determined based on the cost values associated with the combinations of signs.

At (S560), the current block according to the specific combination of signs for the one or more transform coefficients. In an example, a residual block of the current block is reconstructed based on the specific combination of signs for the one or more transform coefficients, and then the current block is reconstructed, for example based on a prediction of the current block and the residual block of the current block.

In some examples, a first cost value associated with a first combination of signs for the one or more transform coefficients is calculated by measuring a discontinuity between reconstructed samples of the current block according to the first combination of signs and reconstructed samples of neighboring blocks.

In some examples, the specific combination is determined to be the one that has a minimal cost value in the cost values.

In some examples, the coded video bitstream is parsed to obtain a maximum number of predicted signs for transform blocks in the current picture from a syntax element signaled at a picture level for the current picture. A first number that defines an upper limit of predicted signs for a current transform block of the current block is assigned according to the maximum number of predicted signs for transform blocks in the current picture. A second number of nonzero transform coefficients in the current transform block of the current block is determines. Then, a minimum of the first number and the second number is selected as the specific number.

In some examples, a control flag for the syntax clement is parsed from the coded video bitstream, the control flag is in at least one of a sequence parameter set (SPS) and a picture parameter set (PPS). When the control flag indicates the syntax element being used, the coded video bitstream is parsed to obtain the maximum number from the syntax element signaled at the picture level.

In some examples, the second number of nonzero transform coefficients in the current transform block of the current block is determined, and the first number is adjusted based on the second number of nonzero transform coefficients. In an example, when the second number is larger than a threshold, the first number is increased. In another example, when the second number is larger than a threshold, the first number is reduced.

In some examples, absolute values of the transform coefficients of the current transform block are parsed from the coded video bitstream. The first number is adjusted based on the absolute values of the transform coefficients. In an example, the first number is adjusted based on a sum of the absolute values of the transform coefficients. In an example, when the sum of the absolute values of the transform coefficients is larger than a threshold, the first number is increased. In another example, when the sum of the absolute values of the transform coefficients is larger than a threshold, the first number is reduced.

In some examples, the first number is adjusted based on coding mode information of the current block, such as whether a secondary transform is applied, whether a specific secondary transform kernel is applied, whether the current block is an intra coded block, and whether the current block is an inter coded block.

In some examples, the first number is adjusted based on an availability of neighboring reconstructed samples. In an example, when top neighboring samples are not available, the first number is reduced. In another example, when left neighboring samples are not available, the first number is reduced.

In some examples, the first number is adjusted based on a value of quantization parameter for a neighboring block. In an example, when the neighboring block is coded with a higher QP value than the current block, the first number is reduced.

In some examples, the first number is adjusted based on a relative location of the current block in a coding tree unit (CTU). In an example, when the current block is located at the top CTU boundary, the first number is reduced. In another example, when the current block is located at the left CTU boundary, the first number is reduced.

Then, the process proceeds to (S599) and terminates.

The process (500) can be suitably adapted. Step(s) in the process (500) can be modified and/or omitted. Additional step(s) can be added. Any suitable order of implementation can be used.

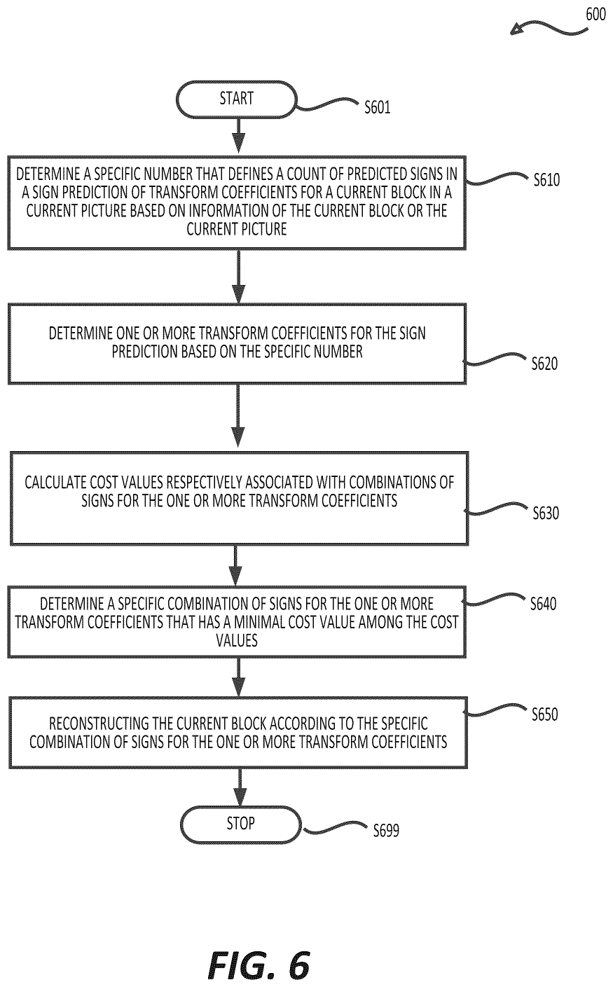

FIG. 6 shows a flow chart outlining a process (600) according to an embodiment of the disclosure. The process (600) can be used in a video encoder. In various embodiments, the process (600) is executed by processing circuitry, such as the processing circuitry that performs functions of the video encoder (103), the processing circuitry that performs functions of the video encoder (303), and the like. In some embodiments, the process (600) is implemented in software instructions, thus when the processing circuitry executes the software instructions, the processing circuitry performs the process (600). The process starts at (S601) and proceeds to (S610).

At (S610), a specific number that defines a count of predicted signs in a sign prediction of transform coefficients for a current block in a current picture is determined based on information of the current block or the current picture.

At (S620), one or more transform coefficients for the sign prediction are determined based on the specific number.

At (S630), cost values respectively associated with combinations of signs for the one or more transform coefficients are calculated.

At (S640), a specific combination of signs for the one or more transform coefficients that has a minimal cost value among the cost values is determined.

At (S650), the current block is reconstructed according to the specific combination of signs for the one or more transform coefficients. In an example, a residual block of the current block is reconstructed based on the specific combination of signs for the one or more transform coefficients, and then the current block is reconstructed, for example based on a prediction of the current block and the residual block of the current block.

In some examples, a first cost value associated with a first combination of signs for the one or more transform coefficients is calculated by measuring a discontinuity between reconstructed samples of the current block according to the first combination of signs and reconstructed samples of one or more neighboring blocks.

In some examples, the specific number is a minimum of a first number that indicates an upper limit of predicted signs for a current transform block of the current block and a second number of nonzero transform coefficients in a current transform block of the current block. The first number is assigned based on a maximum number of predicted signs for transform blocks in the current picture. The maximum number of predicted signs is signaled as a syntax clement at a picture level in a coded video bitstream that includes coded information of the current picture, the syntax element indicates the maximum number of predicted signs for the transform blocks in the current picture.

In some examples, the second number of nonzero transform coefficients in the current transform block of the current block is derived. The first number is adjusted based on the second number of nonzero transform coefficients in the current transform block.

In some examples, the first number is adjusted based on a sum of absolute values of non-zero transform coefficients of the current transform block.

In some examples, the first number is adjusted based on at least one of whether a secondary transform is applied, whether a specific secondary transform kernel is applied, whether the current block is an intra coded block and whether the current block is an inter coded block.

In an example, the first number is adjusted based on an availability of neighboring reconstructed samples. In another example, the first number is adjusted based on a value of quantization parameter for a neighboring block. In another example, the first number is adjusted based on a relative location of the current block in a current coding trec unit (CTU).

Then, the process proceeds to (S699) and terminates.

The process (600) can be suitably adapted. Step(s) in the process (600) can be modified and/or omitted. Additional step(s) can be added. Any suitable order of implementation can be used.

According to an aspect of the disclosure, in some examples, a bitstream of visual media data is processed according to a format rule. The format rule specifies that a specific number that defines a count of predicted signs in a sign prediction of transform coefficients for a current block in a current picture is determined based on information of the current block or the current picture, one or more transform coefficients for the sign prediction are determined based on the specific number, absolute values of the one or more transform coefficients are included in the bitstream, cost values respectively associated with combinations of signs are calculated for the one or more transform coefficients, a first cost value associated with a first combination of signs measures a discontinuity between reconstructed samples of the current block according to the first combination of signs and reconstructed samples of one or more neighboring blocks, a specific combination of signs for the one or more transform coefficients that has a minimal cost value among the cost values is determined, the current block is reconstructed according to the specific combination of signs for the one or more transform coefficients.

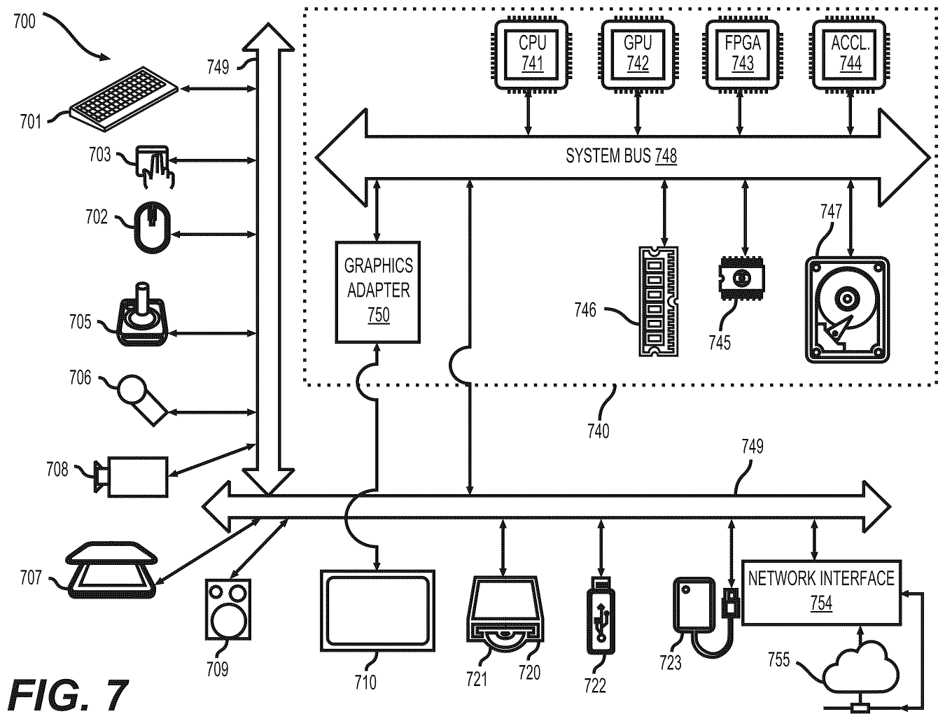

The techniques described above, can be implemented as computer software using computer-readable instructions and physically stored in one or more computer-readable media. For example, FIG. 7 shows a computer system (700) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 7 for computer system (700) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (700).

Computer system (700) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (701), mouse (702), trackpad (703), touch screen (710), data-glove (not shown), joystick (705), microphone (706), scanner (707), camera (708).

Computer system (700) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (710), data-glove (not shown), or joystick (705), but there can also be tactile feedback devices that do not serve as input devices), audio output devices (such as: speakers (709), headphones (not depicted)), visual output devices (such as screens (710) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (700) can also include human accessible storage devices and their associated media such as optical media including CD/DVD ROM/RW (720) with CD/DVD or the like media (721), thumb-drive (722), removable hard drive or solid state drive (723), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (700) can also include an interface (754) to one or more communication networks (755). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (749) (such as, for example USB ports of the computer system (700)); others are commonly integrated into the core of the computer system (700) by attachment to a system bus as described below (for example Ethernet interface into a PC computer system or cellular network interface into a smartphone computer system). Using any of these networks, computer system (700) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (740) of the computer system (700).

The core (740) can include one or more Central Processing Units (CPU) (741), Graphics Processing Units (GPU) (742), specialized programmable processing units in the form of Field Programmable Gate Areas (FPGA) (743), hardware accelerators for certain tasks (744), graphics adapters (750), and so forth. These devices, along with Read-only memory (ROM) (745), Random-access memory (746), internal mass storage such as internal non-user accessible hard drives, SSDs, and the like (747), may be connected through a system bus (748). In some computer systems, the system bus (748) can be accessible in the form of one or more physical plugs to enable extensions by additional CPUs, GPU, and the like. The peripheral devices can be attached either directly to the core's system bus (748), or through a peripheral bus (749). In an example, the screen (710) can be connected to the graphics adapter (750). Architectures for a peripheral bus include PCI, USB, and the like.

CPUs (741), GPUs (742), FPGAs (743), and accelerators (744) can execute certain instructions that, in combination, can make up the aforementioned computer code. That computer code can be stored in ROM (745) or RAM (746). Transitional data can also be stored in RAM (746), whereas permanent data can be stored for example, in the internal mass storage (747). Fast storage and retrieve to any of the memory devices can be enabled through the use of cache memory, that can be closely associated with one or more CPU (741), GPU (742), mass storage (747), ROM (745), RAM (746), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (700), and specifically the core (740) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (740) that are of non-transitory nature, such as core-internal mass storage (747) or ROM (745). The software implementing various embodiments of the present disclosure can be stored in such devices and executed by core (740). A computer-readable medium can include one or more memory devices or chips, according to particular needs. The software can cause the core (740) and specifically the processors therein (including CPU, GPU, FPGA, and the like) to execute particular processes or particular parts of particular processes described herein, including defining data structures stored in RAM (746) and modifying such data structures according to the processes defined by the software. In addition or as an alternative, the computer system can provide functionality as a result of logic hardwired or otherwise embodied in a circuit (for example: accelerator (744)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for video decoding, comprising:
receiving a coded video bitstream comprising coded information of one or more pictures;
determining a number of predicted signs that defines a count of predicted signs in a sign prediction of transform coefficients for a current block in a current picture based on information of the current block;
determining one or more transform coefficients for the sign prediction according to the number of predicted signs;
calculating cost values respectively associated with combinations of signs for the one or more transform coefficients;
determining a specific combination of signs for the one or more transform coefficients based on the cost values associated with the combinations of signs; and
reconstructing the current block according to the specific combination of signs for the one or more transform coefficients.

2. The method of claim 1, wherein the calculating comprises:
calculate a first cost value associated with a first combination of signs for the one or more transform coefficients by measuring a discontinuity between reconstructed samples of the current block according to the first combination of signs and reconstructed samples of neighboring blocks.

3. The method of claim 1, wherein the determining the specific combination comprises:
determining the specific combination that has a minimal cost value in the cost values.

4. The method of claim 1, wherein the determining the number comprises:
parsing the coded video bitstream to obtain a maximum number of predicted signs for transform blocks in the current picture from a syntax element signaled at a picture level for the current picture, a first number defining an upper limit of predicted signs for a current transform block of the current block being assigned according to the maximum number of predicted signs for transform blocks in the current picture;
determining a second number of nonzero transform coefficients in the current transform block of the current block; and
selecting a minimum of the first number and the second number as the number.

5. The method of claim 4, wherein the determining the number comprises:
parsing a control flag for the syntax element from the coded video bitstream, the control flag is in at least one of a sequence parameter set (SPS) and a picture parameter set (PPS); and
when the control flag indicates the syntax element being used, parsing the coded video bitstream to obtain the first number from the syntax element signaled at the picture level.

6. The method of claim 4, wherein the determining the number comprises:
deriving the second number of nonzero transform coefficients in the current transform block of the current block; and
adjusting the first number based on the second number of nonzero transform coefficients.

7. The method of claim 4, wherein the determining the number comprises:
parsing absolute values of the transform coefficients of the current transform block from the coded video bitstream; and
adjusting the first number based on the absolute values of the transform coefficients.

8. The method of claim 7, wherein the adjusting the first number comprises:
adjusting the first number based on a sum of the absolute values of the transform coefficients.

9. The method of claim 4, wherein the determining the number comprises:
adjusting the first number based on at least one of:
whether a secondary transform is applied;
whether a specific secondary transform kernel is applied;
whether the current block is an intra coded block; and
whether the current block is an inter coded block.

10. The method of claim 4, wherein the determining the number comprises:
adjusting the first number based on an availability of neighboring reconstructed samples.

11. The method of claim 4, wherein the determining the number comprises:
adjusting the first number based on a value of quantization parameter for a neighboring block.

12. The method of claim 4, wherein the determining the number comprises:
adjusting the first number based on a relative location of the current block in a coding tree unit (CTU).

13. A method for video encoding, comprising:
determining a number of predicted signs that defines a count of predicted signs in a sign prediction of transform coefficients for a current block in a current picture based on information of the current block;
determining one or more transform coefficients for the sign prediction based on the number of predicted signs for the current block;
calculating cost values respectively associated with combinations of signs for the one or more transform coefficients;
determining a specific combination of signs for the one or more transform coefficients that has a minimal cost value among the cost values; and
encoding the current block according to the specific combination of signs for the one or more transform coefficients.

14. The method of claim 13, wherein the calculating the cost values further comprises:
calculating a first cost value associated with a first combination of signs for the one or more transform coefficients by measuring a discontinuity between reconstructed samples of the current block according to the first combination of signs and reconstructed samples of one or more neighboring blocks.

15. The method of claim 13, wherein the determining the number further comprises:
determining the number that is a minimum of a first number that indicates an upper limit of predicted signs for a current transform block of the current block and a second number of nonzero transform coefficients in a current transform block of the current block, the first number being assigned based on a maximum number of predicted signs for transform blocks in the current picture; and
signaling the maximum number of predicted signs as a syntax element at a picture level in a coded video bitstream that includes coded information of the current picture, the syntax element indicating the maximum number of predicted signs for the transform blocks in the current picture.

16. The method of claim 15, further comprising:
deriving the second number of nonzero transform coefficients in the current transform block of the current block; and
adjusting the first number based on the second number of nonzero transform coefficients in the current transform block.

17. The method of claim 15, further comprising:
adjusting the first number based on a sum of absolute values of non-zero transform coefficients of the current transform block.

18. The method of claim 15, further comprising:
adjusting the first number based on at least one of:
whether a secondary transform is applied;
whether a specific secondary transform kernel is applied;
whether the current block is an intra coded block; and
whether the current block is an inter coded block.

19. The method of claim 15, further comprising:
adjusting the first number based on at least one of:
an availability of neighboring reconstructed samples;
a value of quantization parameter for a neighboring block; and
a relative location of the current block in a current coding tree unit (CTU).

20. A non-transitory computer readable medium storing a video media bitstream that is encoded by an encoding method, the encoding method comprising:
determining a number of predicted signs that defines a count of predicted signs in a sign prediction of transform coefficients for a current block in a current picture based on information of the current block;
determining one or more transform coefficients for the sign prediction based on the number of predicted signs for the current block;
calculating cost values respectively associated with combinations of signs for the one or more transform coefficients;
determining a specific combination of signs for the one or more transform coefficients that has a minimal cost value among the cost values; and
encoding the current block into encoded information in the video media bitstream according to the specific combination of signs for the one or more transform coefficients.
